(19) United States
(12) Patent Application Publication
(10) Pub. No.: US 2010/0317329 A1
(43) Pub. Date: Dec. 16, 2010

(54) Marking and/or Sharing Media Stream in the Cellular Network Terminal

(76) Inventors: Markku Rytivaara, Oulu (FI); Mika Mustonen, Ii (FI); Minna Karukka, Oulu (FI)

Correspondence Address: DITTHAVONG MORI & STEINER, P.C., 918 Prince Street, Alexandria, VA, 22314, US

(21) Appl. No.: 12/860,238

(22) Filed: Aug. 20, 2010

Related U.S. Application Data
(63) Continuation of application No. 11/321,655, filed on Dec. 28, 2005.

(30) Foreign Application Priority Data
Dec. 30, 2004 (FI) 20041689

(51) Int. Cl. H04W 4/00

(52) U.S. Cl. 455/414.1

(57) ABSTRACT

A media clip is marked (156) in a wireless terminal (10) and transmitted further (164) to another wireless terminal (10) in which the marked media stream is received (182) and presented (194) according to the marking (156). A wireless network terminal (10) is shown applying the method, and a programmable means (14, 15, 16, 34, 35) usukkystrated in the wireless network terminal (10) to implement the method. A basis for marking (156) is a playhead position (23, 23a, 23b) which indicates progress of a media clip on a display (11) of the wireless terminal (10), and an end moment of the media clip when the media clip was stopped. This information is associated to playhead information which forms the basis for the marking (156) and reassemblying (184) a media data message (41) before sending it and after receiving it over a wireless network (50).

### CROSS-REFERENCE TO RELATED APPLICATION

This application is a continuation of U.S. application Ser. No. 11/321,655 filed Dec. 28, 2005.

### BACKGROUND OF THE INVENTION

This invention relates generally to a method for processing a media clip in a cellular network terminal for further transmission/reception over a cellular network. More particularly, the invention relates to a method in which a media stream is marked in a cellular terminal and transmitted further to another cellular terminal, and to a method in which a marked media stream is received at a cellular terminal and presented therein according to the marking. The invention also relates to a cellular network terminal applying the method, as well as to a programmable means in a cellular network terminal executing the method.

The amount of media data, such as text messages, speech, images, video clips, audio clips, animation clips and any combination of them, transmitted in cellular telecommunication networks have grown very rapidly in recent years as a result of breakthroughs in the cost and processing power of cellular network terminals, such as mobile stations and wireless multimedia terminals. For example, as digital cameras or videocameras gain in popularity so as to become an integral part of such cellular network terminals they increase the amount of media data processing needed. Modern cellular network terminals are configured to transmit, receive, shoot, store, display and reproduce media data, and they are provided with some media data editing capabilities as well.

However transmitting e.g. a long video clip consumes a lot of transmission capacity of the cellular network. Also memory capacity of the cellular terminal is still rather limited which makes it desirable to store into the terminal only such video clips that the user finds useful or delightful. On the other hand, the video clip to be stored or transmitted may also contain pieces of the action having less informative content and the user may want to shorten or cut those pieces from the video clip before sending it to recipients. For the above reasons there arises a need for the user of the cellular terminal to edit the video clip in the cellular terminal before storing it or transmitting it to another cellular terminal. However, there are not very many easy-to-use tools for editing video clips in cellular terminals at the moment.

The cellular telecommunication networks use wider and wider bandwidth data paths comprising one or more communication channels to transmit information between cellular terminals connected to the cellular telecommunication network. Mostly this information is in compressed form and encapsulated prior to transmission and it is transmitted as an encapsulated packet over the network. There remain, however, problems in transmitting the large volumes of media data over communication networks sufficiently quickly and conveniently to be readily usable by the user.

When the amount of media data is growing rapidly there is always a danger of a recipient losing some substantial information that a sender considered to be most useful. The user of the cellular terminal may not have enough time to edit media data in a proper way before sending the message, or the user may not have enough time to watch or listen the message because it is too long or there are too many messages waiting for access. For instance if the user of the cellular terminal wants to send a movie file to her/his friends' cellular terminals the recipients are obliged to watch the whole movie file through so as to avoid losing any information the sender considered useful for them.

The problems set forth above are overcome by providing searching and retrieving functionality along with a media data message in such a way that the recipient is able quickly and conveniently to reproduce media data on her/his cellular terminal in a form as it was intended by the sender.

### BRIEF SUMMARY OF THE INVENTION

It is an objective of an embodiment of the invention to provide a method and arrangement applicable on a wireless terminal wirelessly connected to a wireless network to enable the user of the terminal to send and/or receive media data, such as text, speech, graphics, images, video clips, audio clips, animation clips and any combination of them, and to process media data on the wireless terminal before sending and after receiving in such a way that media data is in the most convenient form for the recipient of the media data. It is also an objective of an embodiment of the invention to provide a method and arrangement applicable on a wireless terminal wirelessly connected to a wireless network to enable the user of the wireless terminal to transmit and/or receive media data in such processed form.

The objectives of embodiments of the invention are achieved by providing a method and arrangement applicable on a wireless terminal wirelessly connected to a wireless network to enable the user of the wireless terminal to insert into the media data message prior to sending it an indication information which indicates to the recipient the point(s) of media data intended to be most useful for the recipient by the sender. This information is transmitted along with the media data message from the sender's wireless terminal over the wireless network to the recipient's wireless terminal. The recipient's wireless terminal receives this information along with the media data message and identifies this information and the media data is then presented according to this information on the recipient's wireless terminal.

A benefit of the embodied invention provides a solution in which a media clip is transmitted/received from/to the wireless terminal in a form having fast and effective searching and retrieving functionality along with the media data message so that the recipient is able to quickly and conveniently reproduce the media clip on her/his cellular terminal and in a form as it was intended by the sender. Another benefit of the embodied invention is to create an easier and faster way to find out specific point(s) from the media files for consuming and editing purposes.

In accordance with a first aspect of the invention there is provided a method for sending at least one playhead information in a wireless network, where at least one media message comprising media data and a metadata is transferred, at least one playhead indicating progress of at least one media data presentation on the wireless terminal, wherein the method comprises steps of (i) stopping presentation of said media data presentation and said playhead on the wireless terminal, (ii) reading a position of said playhead and a freezed-frame of said media data presentation, (iii) marking a position of said playhead and a freezed-frame to be identified by a playhead information, (iv) inserting the playhead information to the metadata, and (v) sending further the media message comprising at least one playhead information from the wireless terminal.

In accordance with a second aspect of the invention there is provided a wireless terminal for sending and receiving at least one playhead information, said wireless terminal comprising means for sending at least one media data message and means for receiving at least one media data message, said media data message comprising media data and a metadata, means for indicating at least one playhead progressing along a media data presentation and programmable selecting members for controlling said playhead and said at least one media data presentation, wherein the wireless terminal comprises (i) means for stopping presentation of said media data presentation and said playhead, (ii) means for marking a position of said playhead and a freezed-frame of the media data presentation to be identified by a playhead information, and means for reassemblying at least one media message to at least one media data presentation according to said playhead information, (iii) means for inserting the playhead information to the metadata, and means for identifying the playhead information to the metadata, (iv) means for sending and receiving the media message comprising at least one playhead information from the wireless terminal, and (v) means for starting presentation of said media data presentation and said playhead according to said playhead information.

In accordance with a third aspect of the invention there is provided a method for receiving at least one playhead information in a wireless network, where at least one playhead is indicating progress of at least one media data presentation on the wireless terminal, wherein the method comprises steps of (i) receiving on the wireless terminal at least one media message comprising media data and a metadata, (ii) identifying at least one playhead information from said metadata, (iii) reassemblying said at least one media message to at least one media data presentation according to said playhead information, and (iv) presenting said at least one media data presentation according to said playhead information.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

An embodiment of the invention will be described in detail below, by way of example only, with reference to the accompanying drawings, of which

FIG. 1 depicts a flow diagram of sending a playhead information from a wireless terminal according to an embodiment of the invention,

FIG. 2 depicts a block diagram of an exemplary wireless terminal according to an embodiment of the invention,

FIG. 3a depicts an indication arrangement on a display unit according to an embodiment of the invention,

FIG. 3b depicts an indication arrangement on a display unit according to another further embodiment of the invention,

FIG. 3c depicts an indication arrangement on a display unit according to another further embodiment of the invention,

FIG. 4 depicts a block diagram of architectural elements of an wireless network arrangement according to another embodiment of the invention,

FIG. 5 depicts a block diagram of a media data message encapsulated according to a further embodiment of the invention,

FIG. 6 depicts a flow diagram of receiving a playhead information to a wireless terminal according to an embodiment of the invention, and

FIG. 7 depicts main functional blocks of a wireless terminal according to an embodiment of the invention.

### DETAILED DESCRIPTION OF THE INVENTION

According to some embodiments of the invention the following notes are made: In the context of this description it should be understood a term “media clip” meaning that “media data”, such as text, speech, voice, graphics, image, video, audio, animation and any combination of them, is in a form of presentation, such as text clip, video clip, animation clip, audio clip, movie, etc. “Frame” means a single complete digital unit in the media sequence of the media clip, e.g. a single image in the video sequence.

A term “media data message” should be understood to mean that “media data” and/or “media clip” is encapsulated into such a form that it can be transferred via the communication channel over the wireless network, such as short text message, multimedia message, voice message, etc.

When a “media clip” is viewed locally e.g. by a browser and a corresponding “media file” resides in a remote source location a term “media stream(ing)” should be understood to mean that media data is streaming from the remote source location to the browser.

Further, a term “video”, when used in in the context of “video streaming” and “video clip”, should be interpreted as the capability to render simultaneously both video and audio content.

To begin with there is running a media clip on a display of a wireless terminal originating from a media source. Along with the media clip there is running a visible playhead on a time line on the display, wherein the playhead is a graphical and/or numerical indication of an instantaneous position of the media clip in relation to the total original length of the media clip and the time line is a graphical and/or numerical indication of the total original length of the media clip. Both the playhead and time line, as well as running the playhead along the media clip on the same display, are known as such.

According to the objective of the invention a user of the wireless terminal selects by programmable selecting members, preferably soft keys, a sending mode for sending a media data message containing at least information about a desired playhead position along with the media clip running on a display of the wireless terminal to at least one other wireless terminal via a communication channel over the wireless network.

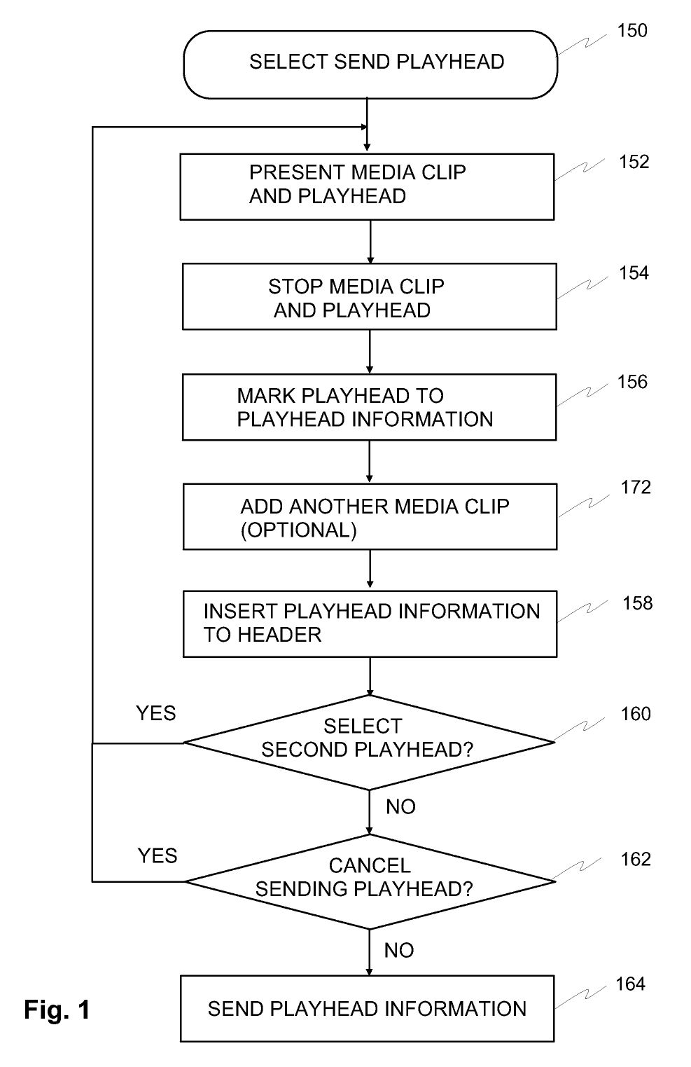

FIG. 1 depicts a flow diagram of the main steps of sending a playhead information from a wireless terminal according to an embodiment of the invention.

According to an embodiment of the invention the user of the wireless terminal further selects by programmable selecting members, preferably soft keys, a sending playhead mode 150 for sending a media data message containing at least one playhead information to at least one other wireless terminal via a communication channel over the wireless network.

In the sending playhead mode according to an embodiment of the invention the user of the wireless terminal is viewing a presentation of a desired media clip and a playhead is running on the time line along with the media clip 152. The user stops the media clip running on the display of the wireless terminal to a desired point 154 by programmable selecting members, preferably soft keys. The playhead running on the time line along with the media clip also stops immediately when the media clip is stopped 154. In a stopped mode a freezed-frame of the media clip, i.e. an end moment of the media clip after stopping, and the playhead position at the very same moment are displayed on the display. Then the user selects by programmable selecting members a marking mode comprising programmable marking means 156 in which marking mode the playhead position is read by programmable reading means. In the marking mode, optionally, the playhead position and the freezed-frame are stored to a memory of the wireless terminal. Next, in the marking mode the playhead position and the freezed-frame of the media clip are combined together by marking means to form a combination, and playhead information is associated to the combination of the playhead position and the freezed-frame in such a way that the combination is identified by the playhead information 156. Then prior to sending the media data message, in the sending playhead mode the playhead information is inserted to a header section of the media data message 158. After this in the sending playhead mode the user selects by programmable selecting members an identification of the receiver and sends further the media data message comprising at least the playhead information 164 via the communication channel over the wireless network. The sender can cancel a sending playhead information according to step 162, as shown in FIG. 1.

Optionally, in the marking mode the playhead position and the corresponding freezed frame of the media clip are stored to a memory of the wireless terminal by programmable selecting members.

Optionally, in the marking mode the playhead information is modified into a form to match for transmission in the sending playhead mode as a media data message via a communication channel over the wireless network. Such a modification procedure is not discussed in more detail in this application as such a procedure will be easy to carry out by anyone of skill in the art.

According to another embodiment of the invention in the marking mode playhead information is associated to the combination of the playhead position and the freezed-frame of the media clip and a source location of the media clip in such a way that both the combination and the source location is identified by the playhead information 156. Then prior to sending the media data message, in the sending playhead mode the playhead information is inserted to a header section of the media data message 158. After this in the sending playhead mode the user selects by programmable selecting members an identification of the receiver and sends further the media data message comprising at least the playhead information 164 via the communication channel over the wireless network.

According to still another embodiment of the invention a media source location is identified in the playhead information based on one of the following information: telephone number, IP address and point-to-point (P2P) connection.

According to another embodiment of the invention in the marking mode playhead information is associated to the combination of the playhead position and the freezed-frame of the media clip, a source location of the media clip and/or the media clip information in such a way that the combination, the source location and media clip information are identified by the playhead information 156. Then prior to sending the media data message, in the sending playhead mode the playhead information is inserted to a header section of the media data message 158. After this in the sending playhead mode the user selects by programmable selecting members an identification of the receiver and sends further the media data message comprising at least the playhead information 164 via the communication channel over the wireless network.

According to still another embodiment of the invention media clip information that is identified in the playhead information comprises at least one the following information of the media clip: file size, file format and duration.

According to a further embodiment of the invention in the marking mode playhead information is associated to the combination of the playhead position and the freezed-frame in such a way that the combination is identified by the playhead information 156. Then, prior to sending the media data message, in the sending playhead mode the playhead information is inserted to a header section of the media data message 158. After this in the sending playhead mode the user selects by programmable selecting members an identification of the receiver and sends further the media data message comprising the playhead information and the media clip 164 via the communication channel over the wireless network.

According to a further embodiment of the invention in the marking mode a first playhead information is associated to the first combination of the first playhead position and the freezed-frame in such a way that the first combination is identified by the first playhead information 156. After this a second playhead information is associated to the second combination of the second playhead position and the freezed-frame in such a way that the second combination is identified by the second playhead information 160. Then, prior to sending the media data message, in the sending playhead mode the first and second playhead information is inserted to a header section of the media data message 158. After this in the sending playhead mode the user selects by programmable selecting members an identification of the receiver and sends further the media data message comprising at least the first and second playhead information 164 via the communication channel over the wireless network.

According to a still further embodiment of the invention in the marking mode playhead information is associated to a first combination of the playhead position and the freezed-frame of a first media clip in such a way that the first combination is identified by the playhead information 156. Next, the user selects by programmable selecting members an adding mode wherein a second media clip is associated to the same playhead information to form a second combination in such a way that the second combination comprises the playhead information and the second media clip 172. Then prior to sending the media data message, in the sending playhead mode the playhead information is inserted to a header section of the media data message 158. After this in the sending playhead mode the user selects by programmable selecting members an identification of the receiver and sends further the media data message comprising the playhead information and the second media clip 164 via the communication channel over the wireless network.

According to a still further embodiment of the invention in the adding mode 172 a second media clip comprises preferably one of the following media data: text, image and audio.

According to a first embodiment of the invention the user of the wireless terminal further selects by programmable selecting members, preferably soft keys, a sending playhead mode for sending a short text message, preferably a short messaging service (SMS) message, containing at least one playhead information 164 to at least one other wireless terminal.

According to a second embodiment of the invention the user of the wireless terminal further selects by programmable selecting members, preferably soft keys, a sending playhead mode for sending a multimedia service (MMS) message containing at least one playhead information 164 to at least one other wireless terminal.

According to a third embodiment of the invention the user of the wireless terminal further selects by programmable selecting members, preferably soft keys, a sending playhead mode for sending an electronic mail message containing at least one playhead information 164 to at least one other wireless terminal.

According to a fourth embodiment of the invention the user of the wireless terminal further selects by programmable selecting members, preferably soft keys, a sending playhead mode for sending a media data message containing at least one playhead information to at least one other wireless terminal 164 via a short range connection, preferably a Bluetooth connection.

According to a fifth embodiment of the invention the user of the wireless terminal further selects by programmable selecting members, preferably soft keys, a sending playhead mode for sending a voice mail message containing at least one playhead information 164 to at least one other wireless terminal

In the following there is discussed more detail about a user interface arrangement relating to the wireless terminal. The playhead and the time line, as described above, are elements of a user interface of the wireless terminal.

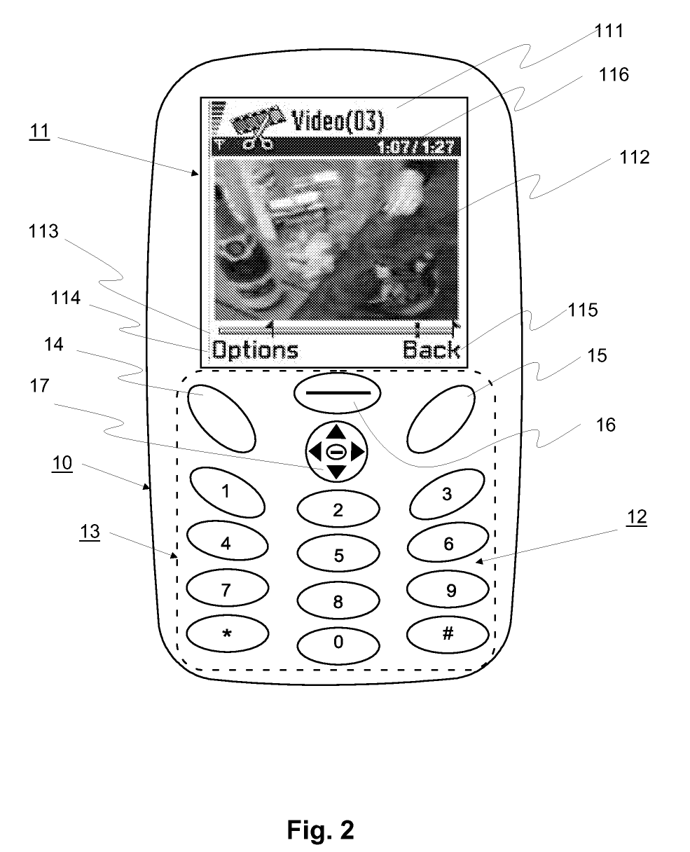

FIG. 2 depicts an exemplary wireless terminal 10, which is known as such, but can be used to transmit/receive playhead information according to an embodiment of the invention. The wireless terminal 10 comprises a display unit 11 capable of displaying/presenting a media clip received from a media source location in addition to traditional display functionality, and a keypad arrangement 13 performing functionality defined by programmable software stored in a memory of the wireless terminal 10. The keypad arrangement comprises alpha-numeric keys 12, a navigation key, preferably a four-way or five-way navigation key 17, and at least one programmable soft key 14, 15, 16. These programmable soft keys 14, 15, 16 are arranged to perform a certain operation to be presented on the display unit 11 of the wireless terminal 10. An exemplary keypad arrangement 13 shown in FIG. 2 is realized by key buttons, but it would be evident to any person skilled in art that the keypad arrangement can also be realized for example as a pattern of touch elements/keys on a touch screen, and consequently a limitation between the display unit 11 and keypad arrangement 13 can be made differently from that shown in figure.

The wireless terminal 10, e.g. a mobile station, communicator, multimedia terminal, video phone, camera phone and the like portable handheld device, is capable of displaying/presenting media data on the display unit 11. The displayed/presented media data is originating from a media source location which can be a video camera integrated to the wireless terminal 10, a storage unit of the wireless terminal 10 or media data stream from a remote media storage, e.g. a server. Media data stream elements received from the media source to the wireless terminal 10 can be in a form of video, animation, audio, text, speech, image and/or any combination of these elements converted into such a format to be displayable/presentable on the display unit 11.

The display unit 11 shown in FIG. 2 comprises some visible zones which are known as such. These visible zones include a headline zone 111 with text and/or symbols, a media zone 112 where a media clip is presented and a indication zone 113. The indication zone 113 presents an indication of an instantaneous position of the media data stream in relation to the total original length of the media clip, i.e. a playhead position and time line as earlier described above. The display unit 11 may also contain an exemplary additional zone 116 which indicates some information of the indication zone 113 in numerical form, such as a playhead position versus time line. Thus, there are alternative ways to express the playhead position on the display 11, namely in the indication zone 113, in the additional zone 116 and both. The additional zone 116 may include to the headline zone 111 or to the media zone 112. The indication zone 113 also comprises operation options 114, 115 which may be associated to soft keys 14, 15. Information of the additional zone 116 can be also part of a media clip presented in the media zone 112 when originating from the media source location along with the media data stream. The media source can be for example any external media application entity connected to the wireless network, a still image or video camera of the wireless terminal 10 itself and/or memory storage unit of the wireless terminal 10 itself. The memory storage is preferably a memory card which can be plugged and played on the wireless terminal 10.

For the point of view of further embodiments of the invention an exemplary wireless terminal 10 as shown in FIG. 2 takes advantage of a display unit 11, soft keys 14, and a soft key, preferably a menu key 16, as well as a navigation key, preferably a five-way navigation key 17. These keys 14, 15, 16, 17 form a basis for the use of the programmable selecting members in the sending playhead mode, as well as in the marking mode according to an embodiment of the invention. As an example, a five-way navigation key 17 may be used to acknowledge the operation options made by any of the soft keys 14, 15, 16. As another example, a five-way navigation key 17 may be used to skip from one point of the media clip to another point according to further embodiments of the invention. In a display unit 11 an indication zone 113 presents a playhead running on the time line. In addition, there are presented in the indication zone 113 operation options 114, 115 which may preferably be associated to soft keys 14, 15. For any person skilled in the art it would be evident that the indication zone 113 may be located also elsewhere on the display unit 11 as shown in FIG. 1. Operation options 114, 115 associated to soft keys 14, 15 may be designated differently than shown in FIG. 2.

In the sending playhead mode according to an embodiment of the invention, as shown in FIG. 2, an operation 114, Options, is associated to a first soft key 14, and another operation 115, Back, is associated to a second soft key 15. According to a further embodiment of the invention a third soft key 16, preferably a menu key, opens up a menu, preferably a pop-up menu, on the display unit 11 to select additional operations therefrom for further processing the media data message before sending it from the wireless terminal 10 and after receiving it from the wireless terminal 10. According to one further embodiment of the invention a third soft key 16 is used as a programmable selecting member in the adding mode, as described later.

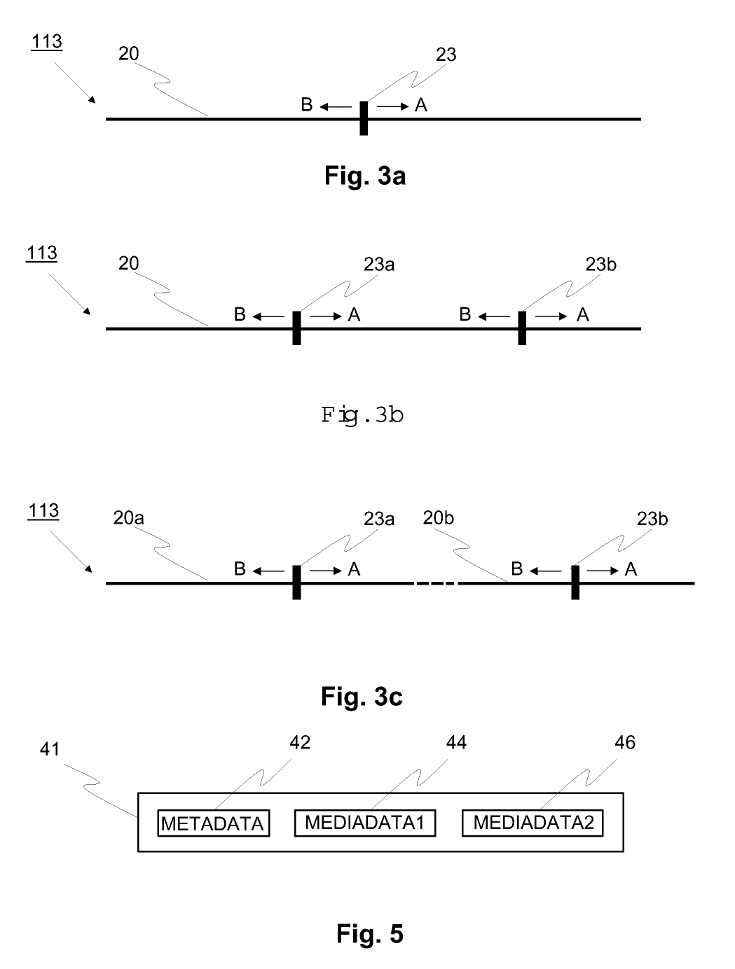

FIG. 3a depicts an indication arrangement to be displayed on the indication zone 113 of the display unit 11, which is known as such, but is applicable in accordance to an embodiment of the invention. The exemplary indication arrangement comprises a timeline 20 which presents a total length of an original media data stream, e.g. a movie or other media clip, in seconds or meters. The exemplary indication arrangement also comprises a playhead 23 which is an indication of an instantaneous position of the media data stream in relation to the total length of the original media clip. In other words, the playhead 23 is moving along the timeline 20 in a direction A when the media clip is presented or reproduced on the media zone 112 of the display unit 11. Respectively, the playhead 23 is moving along the timeline 20 in a direction B when the media clip is played backworks (rewind) on the media zone 112 during presentation, if this kind of functionality is available in the wireless terminal 10.

Next, with reference to FIGS. 2 and 3a-3c, there will be explained in more detail a wireless terminal according to some embodiments of the invention.

According to an embodiment of the invention by pressing a menu key 16 the sending playhead mode is selected for sending a media data message containing at least one playhead information. The sending playhead mode is accepted by the navigation key 17, e.g. by pressing the key. In the sending playhead mode operation options 114, 115 follow instructions programmed in the memory of the wireless terminal 10 and desired operation options 114, 115 are selectable by the adjacent soft keys 14, and/or acknowledged by the navigation key 17. After selecting the sending playhead mode, the next selection is the presentation mode in which a playhead position 23 is running on the timeline along with the presentation of the media clip as it prow ceeds. When the media clip is replayed to a desired stop point and the media clip is stopped at this stop point, the stopped mode is activated by selecting a STOP option from operation options 114, 115 by soft keys 14, 15. If the user wants to change the stop point he/she can do it by selecting the BACK option from operation options 114, 115 by soft keys 14, 15 to continue presentation of the media clip in the media zone 112 and to select a new desired stop point of the media clip running on the display 11. Preferably the STOP option is associated with operation option 114 and soft key 14, and the BACK option with operation option 115 and soft key 15.

In the sending playhead mode according to a further embodiment of the invention a navigation key 17, preferably a five-way navigation key, is used to move the playhead 23 to the direction A or B when such an operation option 114, 115 is selected by soft keys 14, 15 and/or by pressing the navigation key 17 for a short or long period of time. This operation option will help searching and retrieving operations before sending and after receiving a media clip message from/to the wireless terminal 10.

When in the stopped mode the desired stop point of the media clip is selected by the soft keys 14, 15 and acknowledged by the navigation key 17, a freezed-frame of the stop point of the media clip running in the media zone 112 is stopped on the display 11. Naturally, the playhead 23 running on the time line 20 along the media clip is stopped on the display 11 as well. Next, a marking mode comprising programmable marking means is selected by selecting MARK option from operation options 114, 115 by soft keys 14, 15. In the marking mode a playhead position 23 is read by selecting READ PLAYHEAD option 114, 115 with an appropriate soft key 14, 15. Next, in the marking mode a freezed-frame of the media clip is read by selecting READ FRAME option 113, 115 with an appropriate soft key 14, 15. Optionally, the read playhead position 23 and the corresponding freezed-frame are stored to the memory of the wireless terminal 10 by selecting STORE option 114, 115 with an appropriate soft key 14, 15.

Next, in the marking mode the read playhead position 23 and the freezed-frame of the media clip are combined together to form a combination, by selecting COMBINE option 114, 115 with an appropriate soft key 14, 15. When the combination option is acknowledged by the navigation key 17, programmable marking means generates a playhead information which is associated to the combination of the playhead position and the freezed-frame in such a way that the combination is identified by the playhead information. Then, in the marking mode the next operation option 144, 115 is whether the marking step is ready or not. The marking mode is finished by selecting with soft keys 14, 15 e.g. operation option MARK READY 114, 115 and acknowledging it by the navigation key 17, the operation returns to the sending playhead mode. Then, in the sending playhead mode the playhead information is inserted to a header section of the media data message by selecting with soft keys 14, 15 e.g. operation option SEND PLAYHEAD 114, 115 and acknowledging it by the navigation key 17. After this the user selects an identification of the recipient/receiver by selecting it, e.g. phone number, with soft key 16 from a list stored in the memory or using the alpha-numeric keys 12, and after acknowledging it by the navigation key 17 the media data message comprising at least one playhead information is sent to the receiver's wireless terminal 10. It would be evident to any person skilled in the art that the order of proceeding steps may vary from described above, and that the designations of operation options described above are only exemplary designations.

According to another embodiment of the invention in the marking mode the read playhead position 23 and the freezed-frame of the media clip, and a source location of the media clip are combined together to form a combination, by first selecting COMBINE option 114, 115 with an appropriate soft key 14, 15 and then e.g. COMBINE SOURCE option 114, 115 with an appropriate soft key 14, 15. When all steps of the combination option are acknowledged by the navigation key 17, programmable marking means generates a playhead information which is associated to the combination of the playhead position and the freezed-frame in such a way that the combination and the source location is identified by the playhead information. All other steps are as described in the previous paragraph.

According to still another embodiment of the invention in the marking mode the read playhead position 23 and the freezed-frame of the media clip, a source location of the media clip, and a media clip information are combined together to form a combination, by first selecting COMBINE option 114, 115 with an appropriate soft key 14, 15 and then e.g. COMBINE SOURCE option 114, 115 with an appropriate soft key 14, 15 and finally e.g. COMBINE INFO option 114, 115 with an appropriate soft key 14, 15. When all steps of the combination option are acknowledged by the navigation key 17, programmable marking means generates a playhead information which is associated to the combination of the playhead position and the freezed-frame in such a way that the combination and the source location is identified by the playhead information. All other steps are as described in the paragraph preceding the previous paragraph.

According to a further embodiment of the invention in the marking mode the read playhead position 23 and the freezed-frame of the media clip are combined together to form a combination, by selecting COMBINE option 114, 115 with an appropriate soft key 14, 15, as described earlier. When the combination option is acknowledged by the navigation key 17, programmable marking means generates a playhead information which is associated to the combination of the playhead position and the freezed-frame in such a way that the combination is identified by the playhead information. Next, in the sending playhead mode there is a further step to select SEND MEDIA option 114, 115 with an appropriate soft key 14, 15 and if SEND MEDIA option 114, 115 is acknowledged to be OK by the navigation key 17 also the media clip is added to the media data message. Then, in the sending playhead mode the playhead information is inserted to a header section of the media data message by selecting with soft keys 14, 15 e.g. operation option SEND PLAYHEAD 114, 115 and acknowledging it by the navigation key 17. After this the user selects an identification of the recipient/receiver by selecting it with soft key 16 from a list stored in the memory or using the alpha-numeric keys 12, and after acknowledging the selection by the navigation key 17 the media data message comprising the playhead information and the media clip is sent to the receiver's wireless terminal 10. It will be evident to any person skilled in the art that the order of proceeding steps may vary from that described above, and that the designations of operational options described above are only exemplary designations.

According to a further embodiment of the invention in the sending playhead mode after selecting SEND MEDIA option 114, 115 with an appropriate soft key 14, 15, there is selected a further step of ADD MEDIA option 114, 115 and if this option is acknowledged by the navigation key 17, the user can add to the media data message an additional media clip which is independent of the original combination of the playhead position 23 and the freezed-frame of the media clip. In the adding mode the additional media clip is associated to the playhead information of the combination. Then in the send playhead mode the media data message comprising the playhead information and the additional media clip is sent to the receiver's wireless terminal 10. The additional media clip comprises media data preferably in a form of text, image and/or audio.

FIG. 3b depicts an indication arrangement to be displayed on the indication zone 113 of the display unit 11 according to a further embodiment of the invention. The playhead 23 is moving along the timeline 20 when the media clip is presented on the media zone 112 of the display unit 11. When the sending playhead mode is selected, the next step is to select playhead position 23 by running the media clip to a desired stop point and stopping the media clip at this stop point. After selecting the send playhead mode from the menu key 16, the stopped mode is selected as described earlier. In the stopped mode a first desired stop point of the media clip is selected by the soft keys 14, 15 and upon acknowledging it by the navigation key 17 a first freezed-frame of the first stop point of the media clip running in the media zone 112 is stopped on the display 11. The first playhead 23a running on the time line 20 along the media clip is stopped on the display 11 as well. Then, in the marking mode a first playhead position 23a is read by selecting READ PLAYHEAD option 114, 115 with an appropriate soft key 14, 15. Next, a first freezed-frame of the media clip is read by selecting READ FRAME option 113, 115 with an appropriate soft key 14, 15. The read first playhead position 23a and the corresponding freezed-frame are stored to the memory of the wireless terminal 10 by selecting STORE option 114, 115 with an appropriate soft key 14, 15. In the marking mode the read first playhead position 23a and the first freezed-frame of the media clip are combined together to form a first combination, by selecting COMBINE option 114, 115 with an appropriate soft key 14, 15, as described earlier. When the combination option is acknowledged by the navigation key 17, programmable marking means generates a first playhead information which is associated to the first combination of the first playhead position and the first freezed-frame in such a way that the first combination is identified by the first playhead information. First selecting MARK OUT option 114, 115 with an appropriate soft key 14, 15, and then STOP OUT option 114, 115 with an appropriate soft key 14, 15, we are back in the presentation mode under the send playhead mode. Now, the playhead 23 is again moving along the timeline 20 when the media clip is presented on the media zone 112 of the display unit 11. A second desired stop point of the media clip is selected by the soft keys 14, 15 and upon acknowledging it by the navigation key 17, a stopped mode is selected, and a second freezed-frame of the second stop point of the media clip running in the media zone 112 is stopped on the display 11. The second playhead 23b running on the time line 20 along the media clip is stopped on the display 11 as well. Then, in the marking mode a second playhead position 23b is read by selecting READ PLAYHEAD option 114, 115 with an appropriate soft key 14, 15. Next, a second freezed-frame of the media clip is read by selecting READ FRAME option 113, 115 with an appropriate soft key 14, 15. The read second playhead position 23b and the corresponding freezed-frame are stored to the memory of the wireless terminal 10 by selecting STORE option 114, 115 with an appropriate soft key 14, 15. In the marking mode the read second playhead position 23b and the second freezed-frame of the media clip are combined together to form a second combination, by selecting COMBINE option 114, 115 with an appropriate soft key 14, 15, as described earlier. When the combination option is acknowledged by the navigation key 17, programmable marking means generates a second playhead information which is associated to the second combination of the second playhead position and the second freezed-frame in such a way that the second combination is identified by the second playhead information. Then, in the sending playhead mode the first and second playhead information are inserted to a header section of the media data message by selecting with soft keys 14, 15 e.g. operation option SEND PLAYHEAD 114, 115 and acknowledging it by the navigation key 17. After this the user selects an identification of the recipient/receiver by selecting it with soft key 16 from a list stored in the memory or using the alpha-numeric keys 12, and after acknowledging the selection by the navigation key 17 the media data message comprising at least the first and second playhead information is sent to the receiver's wireless terminal 10. It would be obvious to a person skilled in the art that any number of playhead positions 23, 23a, 23b could be defined on one timeline 20.

FIG. 3c depicts an indication arrangement according to still further embodiment of the invention, wherein at first, a first playhead position 23a on a first timeline 20a and a freezed-frame of a first media clip is combined in the stopped mode to form a first combination, as described earlier. The first combination is then associated to a first playhead information. Secondly, a second playhead position 23b on a second timeline 20b and a freezed-frame of a second media clip is combined in the stopped mode to form a second combination, as described earlier. The second combination is then associated to a second playhead information. Now, in the marking mode by selecting again COMBINE option 114, 115 with an appropriate soft key 14, 15, the first and second playhead information are combined. When all steps of the combination option are acknowledged by the navigation key 17, programmable marking means generates a new playhead information which is associated to a new combination of the first combination and the second combination, wherein the first combination is a combination of the first playhead position and the freezed-frame of the first media clip, and the second combination is a combination of the second playhead position and the freezed-frame of the second media clip in such a way that the new combination is identified by the new playhead information.

According to a still further embodiment of the invention, a navigation key 17, preferable a five-way navigation key, is used to move to the playhead position 23 of the media clip. According to a still another further embodiment of the invention, a navigation key 17, preferably a five-way navigation key, is used to skip from the first playhead position 23a of the media clip to the second playhead position 23b of the media clip and vice versa, i.e. to skip between the first playhead position 23a and the second playhead position 23b. This enables fast and effective searching and retrieving functionality within the media clip, as well as within different media clips on the wireless terminal 10. The recipient is able to quickly and conveniently reproduce the media clip on her/his cellular terminal starting from the points selected by the sender. This functionality also enables an easier and faster way to find out specific point(s) from the media files for consuming and editing purposes.

According to a first embodiment of the invention the user of the wireless terminal further selects in the sending playhead mode, after at least one playhead information is inserted to a header section of the media data message, by selecting with soft keys 14, 15 e.g. an operation option SEND PLAYHEAD AS 114, 115. Then by selecting e.g. by the menu key 16 an option to send a short text message, preferably a short messaging service (SMS) message, and acknowledging it by the navigation key 17, a short text message, preferably a short messaging service (SMS) message containing at least playhead information is transmitted to at least one other wireless terminal.

According to a second embodiment of the invention the user of the wireless terminal further selects in the sending playhead mode, after at least one playhead information is inserted to a header section of the media data message, by selecting with soft keys 14, 15 e.g. an operation option SEND PLAYHEAD AS 114, 115. Then by selecting e.g. by the menu key 16 an option to send a multimedia service (MMS) message and acknowledging it by the navigation key 17, a multimedia service (MMS) message containing at least playhead information is transmitted to at least one other wireless terminal.

According to a third embodiment of the invention the user of the wireless terminal further selects in the sending playhead mode, after at least one playhead information is inserted to a header section of the media data message, by selecting with soft keys 14, 15 e.g. operation option SEND PLAYHEAD AS 114, 115. Then by selecting e.g. by the menu key 16 an option to send an electronic mail message and acknowledging it by the navigation key 17, an electronic mail message containing at least to playhead information is transmitted to at least one other wireless terminal.

According to a fourth embodiment of the invention the user of the wireless terminal further selects in the sending playhead mode, after at least one playhead information is inserted to a header section of the media data message, by selecting with soft keys 14, 15 e.g. an operation option SEND PLAYHEAD AS 114, 115. Then by selecting e.g. by the menu key 16 an option to send a media data message via a short range connection, preferably a Bluetooth connection and acknowledging it by the navigation key 17, a media data message containing at least playhead information is trans-mitted to at least one other wireless terminal via a short range connection, preferably a Bluetooth connection.

According to a fifth embodiment of the invention the user of the wireless terminal further selects in the sending playhead mode, after at least one playhead information is inserted to a header section of the media data message, by selecting with soft keys 14, 15 e.g. an operation option SEND PLAYHEAD AS 114, 115. Then by selecting e.g. by the menu key 16 an option to send a voice mail message and acknowledging it by the navigation key 17, a voice mail message containing at least playhead information is transmitted to at least one other wireless terminal.

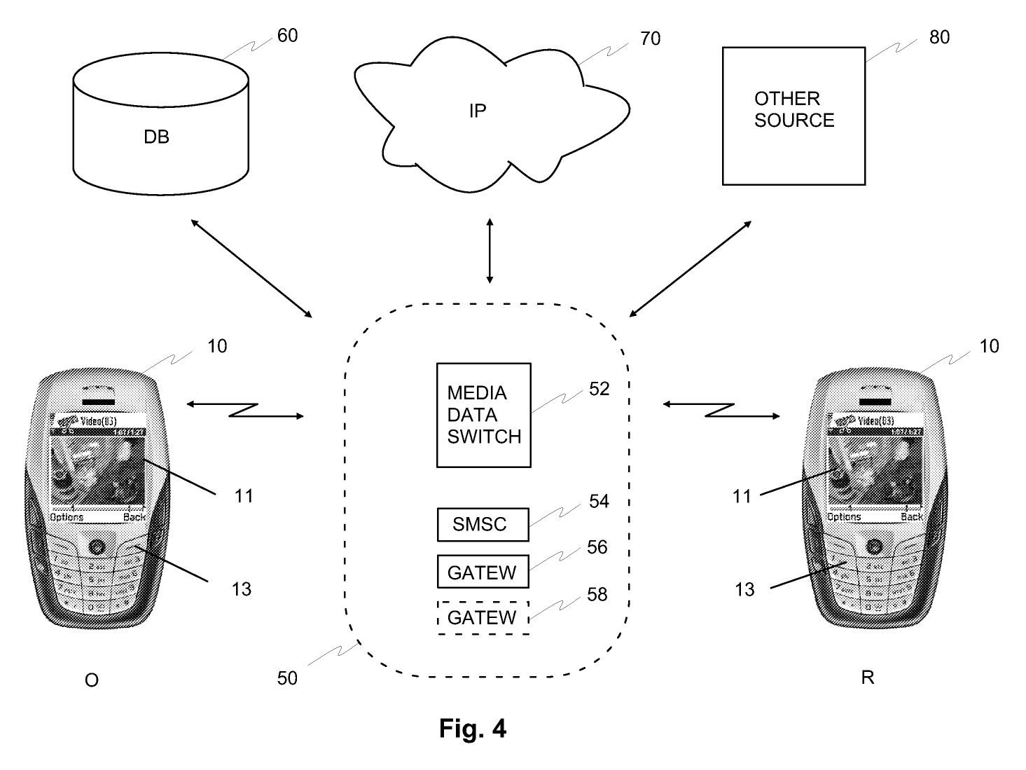

FIG. 4 depicts architectural elements of an exemplary wireless network arrangement for transmitting and receiving over the wireless network media data messages comprising a media data stream, e.g. a video, animation, audio, text, speech, images and/or any combination of them. An exemplary wireless terminal 10 according to an embodiment of the invention comprises a display unit 11 for displaying a media data stream received from a media source and a key arrangement 13 for performing functionality defined by programmable software stored in a memory of the wireless terminal. The wireless terminal 10 communicates wirelessly via wireless network 50 to other wireless terminals connected to the same wireless network or to other wireless terminals connected to other wireless and/or fixed networks. The wireless network 50 comprises network elements to route connections between wireless terminals 10 as well as between wireless terminals 10 and external/operator service applications residing in an database server 60, Internet server 70 or any other service source entity 80. These external/operator application entities 60, 70, 80 typically offer free of charge or on a subscriber basis service content e.g. movies, games, music and the like which the user of the wireless terminal can select using a browsing software, and load via the wireless network 50 to his/her terminal 10 and view the content on to the display unit 11 using viewing software. Exemplary network elements of the wireless network 50 include a media data message switching center 52 capable of handling media data messages, a short message switching center 54 capable of handling short text messages, and appropriate gateway capacity 56, 58 for e-mail communication and other operations if needed.

As shown in FIG. 4, the wireless terminal 10, e.g. a mobile station, communicator, multimedia terminal, video phone, camera phone and the like portable handheld device, communicates wirelessly via wireless network 50 to another wireless terminal 10 connected to the same or to another wireless network wireless. These wireless terminals 10 are capable of sending and receiving media data messages, such as multimedia messaging service (MMS) messages according to wireless application protocol (WAP) protocol, which is known as such. The MMS messages are trans-ferred over the wireless network 50 for example in an encapsulated form so that it is exactly defined how the MMS message is built up and what bytes of the message should go where. The multimedia service center (MMSC) is an exemplary switching network element 52 which handles and routes the MMS messages from the sender's wireless terminal O (originator) to the recipient's wireless terminal R (receiver) over the wireless network 50 in a known way.

Exemplary procedure steps of transmitting/receiving a MMS message over the wireless network in a known way is presented in the following with reference to FIG. 4. The sender O of the MMS message addresses the message to the receiver R. The sender's wireless terminal O contains information about the MMSC 52 it belongs to, initiates a WAP connection, and sends the MMS message as content of an encapsulated mode, e.g. as MMS packet data units (PDU) defined by the WAP protocol to the MMSC 52 via a WAP gateway 56. Then the MMSC 52 accepts the MMS message and responds to the sender O over the same WAP connection via the WAP gateway 56. The sender's wireless terminal O indicates “message sent”. After this the MMSC 52 informs the receiver R by sending a notification message that there is the MMS message waiting. The MMSC 52 sends this notification message as a conventional short message service (SMS) message via a short message service center (SMSC) 54 to the receiver R. Assuming that the receiver's wireless terminal R is set to accept MMS operation, it initiates a WAP connection and prepares to the encapsulated mode to retrieve the MMS message from the MMSC 52. Next the MMS message is sent to the receiver R as content of the encapsulated mode over the same WAP connection via the WAP gateway 56, and the receiver's wireless terminal R indicates “message received”. The receiver's wireless terminal R acknowledges reception over the same WAP connection via the WAP gateway 56 to the MMSC 52. Finally, the MMSC 52 informs the sender O by sending a notification message that the MMS message was delivered, and the sender's wireless terminal O indicates “message delivered”. Now the receiver R can view the MMS message on the display 11 of her/his wireless terminal R.

External/operator service applications residing in the database server 60, Internet server 70 or any other service source entity 80 are accessible to the sender's and receiver's wireless terminals 10 via the MMSC 52 which on its side handles connections to those external entities 60, 70, 80 via appropriate gateway capacity 58, e.g. a mail gateway. When the sender's wireless terminal O is wirelessly connected to a first wireless network 50 having a first MMSC 52 and the receiver's wireless terminal R is wirelessly connected to a second wireless network having a second MMSC, there will be an additional procedure step a connection between the first and the second MMSCs. In other words if the indication “message delivered” is to be sent to the sender O, it is first sent from the second MMSC to the first MMSC, and then the first MMSC send it to the sender O.

According to an embodiment of the invention it is preferable to arrange different types of messages such as text messages, e-mail messages, voice messages, speech messages, image messages, video clips, audio clips, animation clips and any combination of them to be encapsulated as media data messages for transmission over the wireless network 50.

FIG. 5 depicts a block diagram of a media data message encapsulation according to a further embodiment of the invention when transmitting/receiving the media data message from/to the wireless terminal 10. A media data message 41 comprises a header section 42, also called a metadata block, and at least one media data block 44, 46 and the media data message 41 converted in an encapsulated form. The media data message is encapsulated in such a form that the header block 42 contains all relevant sender, receiver, delivering and routing information of the encapsulated message over the wireless network 50. The header block 42 also contains source location, file size, file format, duration, and other relevant information about media data stream, e.g. a media clip, that is encapsulated to the media data message 41. The actual media data content is encapsulated to the media data blocks 44, 46, for example a video data stream to a first media data block 44 and an audio data stream to a second media data block 46, etc. The header block 42 contains e.g. information about file format which expresses how the first and second media data blocks are organized to be accessed for decoding and playback on the wireless terminal 10 or streamed over a transmission channel from the remote host 60, 70, 80 to the wireless terminal 10. In other words, upon reception, information of the header block 42 is used to reconstruct the media data content of the media data message in such a synchronized form that the media data content is displayable on the display unit 11 of the wireless terminal 10. It would be evident to any person skilled in the art that the media data message 41 may contain any number of media data blocks 44, 46 with relation to one or more header blocks 42.

As described earlier, prior to sending the media data message, in the sending playhead mode at least one playhead information is inserted to a header section 42 of the media data message 41. According to an embodiment of the invention the playhead information in the header section 42 comprises at least information of the playhead position 23 and the freezed-frame of the media clip. According to another embodiment of the invention the playhead information in the header section 42 comprises at least information of the playhead position 23 and the freezed-frame of the media clip, and of the source location of the media clip. According to still another embodiment of the invention the playhead information in the header section 42 comprises at least information of the playhead position 23 and the freezed-frame of the media clip, of the source location of the media clip, and of other relevant media clip information.

According to a further embodiment of the invention, prior to sending the media data message, in the sending playhead mode also an option to send the media clip is selected. Then at least one playhead information is inserted to a header section 42 of the media data message 41 and the media clip is encapsulated to media blocks 44, 46 of the media data message 41. The playhead information in the header section 42 comprises at least information of the playhead position 23 and the freezed-frame of the media clip, and of the media clip.

According to a still further embodiment of the invention, prior to sending the media data message, in the sending playhead mode also an option is selected to associate in the adding mode an additional media clip to the playhead information. Then at least one playhead information is inserted to a header section 42 of the media data message 41 and the additional media clip is encapsulated to media blocks 44, 46 of the media data message 41. The playhead information in the header section 42 comprises at least information of the playhead position 23 and the freezed-frame of the media clip, and of the additional media clip.

Upon reception of a media data message, at the receiver's wireless terminal 10 an encapsulated media data message 41 is decoded according to information of the header block 42 and the media data content of media block 44, 46 is reconstructed according to that information. The playhead information of the header block 42 is identified and the content of the playhead information is interpreted and consequently reassembled in such a way that it is displayable/presentable on the display 11 of the wireless terminal 10 at the receiving end.

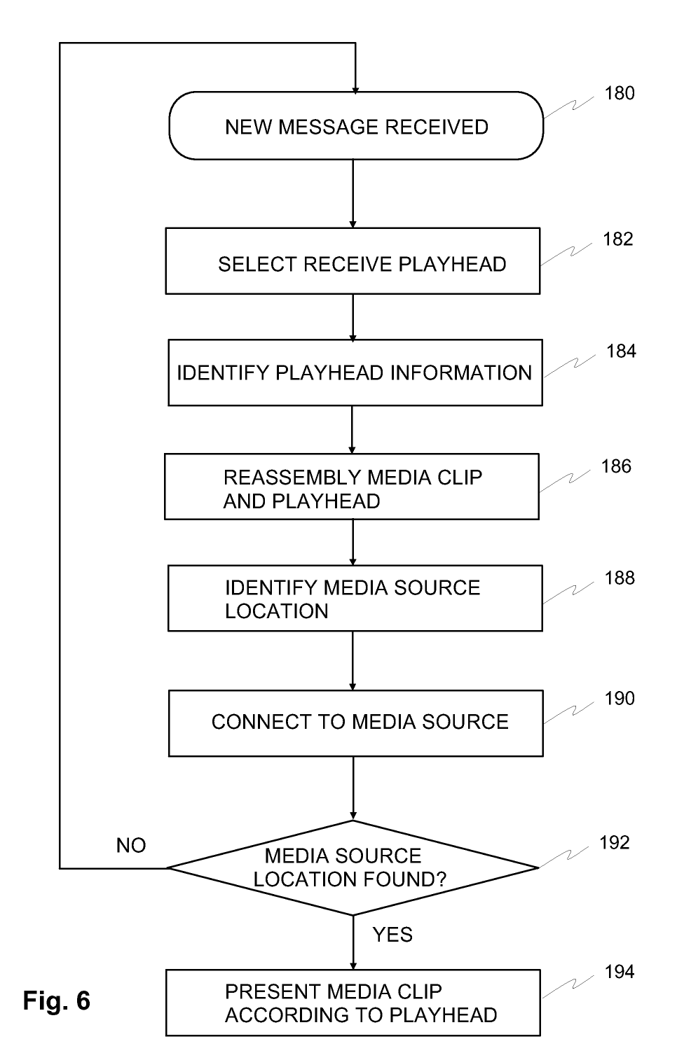

FIG. 6 depicts a flow diagram of receiving a playhead information on a wireless terminal according to an embodiment of the invention. To begin with there is received on the wireless terminal 10 an indication of an arrival of a media data message, i.e. a “new message received” indication 180. On the receiving end the wireless terminal 10 comprises programmable selecting members, preferably soft keys, to select a receiving playhead mode 182 for receiving and reading a media data message containing at least one playhead information from at least one other wireless terminal via a communication channel over the wireless network.

According to an embodiment of the invention, in the receiving playhead mode, the wireless terminal 10 comprises programmable means for identifying and reading the playhead information from the media data message received 184, which playhead information comprises at least information of a combination of the playhead position 23 and the freezed-frame of the media clip. In the reassemblying mode, on the basis of the combination, programmable reassemblying means are used to reconstruct the playhead position 23 and the media clip to be synchronized together by means of the freezed-frame of the media clip 186. After reconstructing the media clip, it is ready to be displayed/presented on the display unit 11 of the wireless terminal 10. Finally, in the presenting mode, the media clip is presented starting from the point of the playhead 23 on the receiver's wireless terminal 10 according to step 194.

According to another embodiment of the invention the playhead information comprises at least information of a combination of the playhead position 23 and the freezed-frame of the media clip, and of the source location of the media clip. In the receiving playhead mode 182, the wireless terminal 10 comprises programmable means for identifying and reading the playhead information from the media data message received 184. On the basis of the combination the programmable reassemblying means are used to reconstruct the playhead position 23 and the media clip to be synchronized together to be ready to be displayed/presented on the display unit 11 of the wireless terminal 10, step 186. The source location of the media clip is identified from the combination 188, and the receiver's wireless terminal 10 initiates to access the identified media source location and to search the proper media clip from the identified media source 190. After the search is completed the wireless terminal 10 is connected to a media source of the media clip to order/receive a corresponding media data stream 192. Then the playhead position 23 and the media clip are synchronized together by means of the freezed-frame of the media clip. Finally, in the presenting mode, the media clip is presented starting from the point of the playhead 23 on the receiver's wireless terminal 10 according to step 194.

According to still another embodiment of the invention the playhead information comprises at least information of the playhead position 23 and the freezed-frame of the media clip, of the source location of the media clip, and/or of other relevant media clip information. In the receiving playhead mode 182, the wireless terminal 10 comprises programmable means for identifying and reading the playhead information from the media data message received 184. On the basis of the combination, the programmable reassemblying means are used to reconstruct the playhead position 23 and the media clip to be synchronized together to be ready to be displayed/presented on the display unit 11 of the wireless terminal 10, in a step 186. The source location of the media clip and/or other relevant media clip information is identified from the combination 188. Before initiating access to the media source location, there is available to the user of the wireless terminal 10 relevant information about a media clip file and duration of the media clip. Then the receiver's wireless terminal 10 initiates an access to the identified media source location and a search for the proper media clip from the identified media source 190. After the search the receiver's wireless terminal 10 is connected to a media source location of the media clip to order/receive a corresponding media data stream 192. Then the playhead position 23 and the media clip are synchronized together by means of the freezed-frame of the media clip. Finally, in the presenting mode, the media clip is presented starting from the point of the playhead 23 on the receiver's wireless terminal 10 according to step 194.

According to a further embodiment of the invention the playhead information comprises at least information of the playhead position 23 and the freezed-frame of the media clip. The receiver's wireless terminal 10 now receives a media data message comprising at least one playhead information and the media clip itself 180. On the basis of the combination, the programmable reassemblying means are used to reconstruct the playhead position 23 and the media clip to be synchronized together by means of the freezed-frame of the media clip to be ready to be displayed/presented on the display unit 11 of the wireless terminal 10, step 186. Finally, in the presenting mode, the media clip is presented starting from the point of the playhead 23 on the receiver's wireless terminal 10, step 194.

According to a further embodiment of the invention a first playhead information comprises at least information of a first combination of the first playhead position 23a and the first freezed-frame of the media clip, a second playhead information comprises at least information of a second combination of the second playhead position 23b and the second freezed-frame of the media clip. The receiver's wireless terminal 10 now receives a media data message comprising at least first playhead information and second playhead information 180. On the basis of the first combination programmable reassemblying means reconstruct the first playhead position 23a and the media clip to be synchronized together by means of the first freezed-frame of the media clip 186. Then, on the basis of the second combination programmable reassemblying means reconstruct the second playhead position 23b and the media clip to be synchronized together by means of the second freezed-frame of the media clip 186. After this the first and second playhead 23a, 23b and the media clip are to be synchronized together by means of the first and second freezed-frame of the media clip, respectively, to be ready to be displayed/presented on the display unit 11 of the wireless terminal 10, step 186. Then, in the presenting mode, the media clip is presented starting from the point of the first playhead 23a or the second playhead 23b on the receiver's wireless terminal 10, step 194. The recipient may choose between those playhead position 23a, 23b by selecting the desired position with a navigation key 17.

According to a still further embodiment of the invention a first playhead information comprises at least information about a first combination of the first playhead position 23a and the freezed-frame of a first media clip, and a second combination comprising a second media clip. On the basis of the first combination, the programmable reassemblying means reconstruct the first playhead position 23a and the media clip to be synchronized together by means of the freezed-frame of the first media clip 186. Then, the second media clip is added to the first playhead position 23a in such a way as to be synchronized together with the first playhead position so as to be ready to be displayed/presented on the display unit 11 of the wireless terminal 10, step 186. Finally, in the presenting mode, the first media clip and/or the second media clip is presented starting from the point of the first playhead 23a on the receiver's wireless terminal 10, step 194.

In the receiving playhead mode according to an embodiment of the invention, as shown in accordance with FIG. 2, an operation 114, Options, is associated to a first soft key 14, and another operation 115, Back, is associated to a second soft key 15. According to a further embodiment of the invention a third soft key 16, preferably a menu key, opens up a menu, preferably a pop-up menu, on the display unit 11 to select additional operations therefrom for further processing the media data message after receiving it from the sender's wireless terminal 10.

Upon reception, after a “new message received” indication is acknowledged by the navigation key 17, preferably a five-way navigation key, the receiver's wireless terminal 10 is ready to initiate opening up the media data message that has arrived. According to an embodiment of the invention a “new playhead message received” indication is acknowledged by the navigation key 17, preferably a five-way navigation key. The wireless terminal transfers to the receiving playhead mode if receiving playhead mode operation options 114, 115, which follow instructions programmed in the memory of the wireless terminal 10, is selected by the appropriate soft keys 14, 15 and/or 16. After programmable means for identifying and reading have identified the playhead information, in the receiving playhead mode, there is activated VIEW PLAYHEAD option 114, 115 according to selection of soft keys 14, 15. If the user wants to postpone the viewing then he/she selects NOT NOW or BACK acknowledgement with soft keys 14, 15 or the selection is YES, as an example. In the latter case the reassemblying mode is activated and programmable reassemblying means to reconstruct the message, as earlier described. Finally, PRESENT MESSAGE option 114, 115 is selected by soft key 14, 15 to present the content of the media data message starting from the point of the playhead 23.

According to another embodiment of the invention PRESENT MESSAGE option 114, 115 selected by soft key 14, 15 comprises a further selecting step of presenting the media clip from a first playhead 23a or from a second playhead 23b. In the presenting mode according to a further embodiment of the invention a navigation key 17, preferably a five-way navigation key, is used to move from the first playhead 23a to the second playhead 23b by pressing the navigation key 17. This operation option will help searching and retrieving operations after receiving a media clip message to the wireless terminal 10. It would be evident to any person skilled in the art that the order of the proceeding steps may vary from that described above, and that the designations of operation options described above are only exemplary designations.

Further, before sending and after receiving the playhead information, there are on the wireless terminal 10 available key buttons for opening pop-up menus to support certain sending and processing options of the playhead information of the media clip. Also, for example, a five-way navigation key may be used to skip from one point of the media clip to another according to the playhead position.

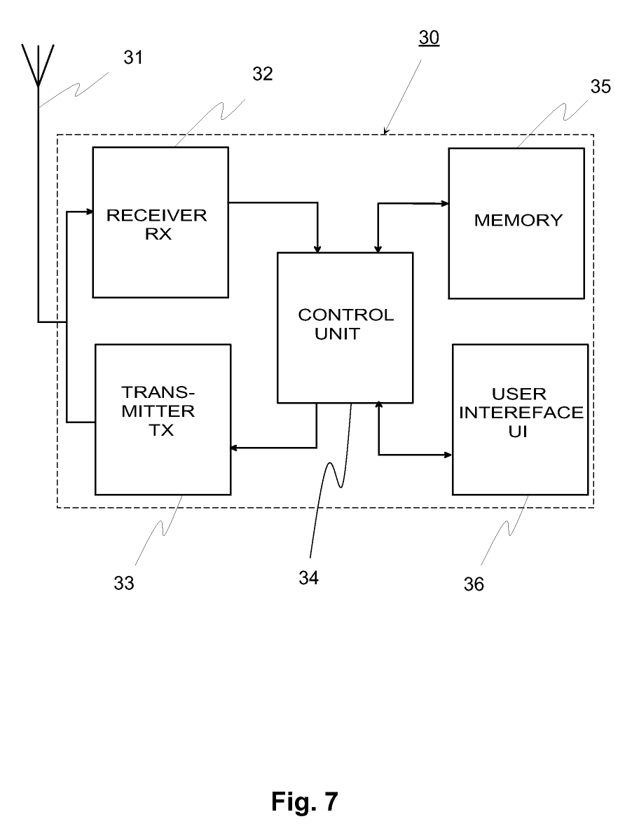

FIG. 7 depicts main functional blocks 30 of a wireless terminal 10 according to an embodiment of the invention. The wireless terminal 10 is a mobile station, multimedia terminal, video phone and the like portable handheld device, which use an antenna 31 for sending and receiving signals via a communication channel over the wireless network 50. The wireless terminal 10 comprises a receiver 32 and transmitter portion 33 or a combined transceiver portion 32, 33 to transmit and receive signals and media data messages. From the point of view of further embodiments of the invention, the main functional blocks 30 of the wireless terminal 10 are a control unit 34 and the user interface 36 comprising the display unit 11 and the key arrangement 13 according to FIG. 2. The control unit 34 controls a memory unit 35 of the wireless terminal 10, to which memory unit 35 are stored programmable applications to implement steps of a method for sending playhead information according to an embodiment of the invention and steps of a method for receiving playhead information according to an embodiment of the invention. The control unit 34 also controls execution of the above method steps. The programmable product according to an embodiment of the invention is arranged to control execution of steps of a method for sending playhead information and method for receiving playhead information.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is intention, therefore, to be limited only as indicated by scope of the claims appended hereto.

1. A method comprising:
sending at least one playhead information via a wireless network by a user of a sending wireless terminal, where at least one media message comprising media data and a metadata is transferred, at least one playhead for indicating progress of at least one media data presentation on a receiving wireless terminal, wherein the method further comprises the sending wireless terminal:
to stopping presentation of said media data presentation and said playhead on the sending wireless terminal,
reading a position of said playhead and a freezed-frame of said media data presentation,
marking a position of said playhead and a freezed-frame to be identified by a playhead information as an indication marked by the user of the sending wireless terminal of a point in said media data for a user of the receiving wireless terminal,
inserting the playhead information to the metadata, and
sending further the media message comprising at least one playhead information from the sending wireless terminal to the receiving wireless terminal enabling said user of the receiving terminal to identify said point in said media data marked by said user of the sending wireless terminal.

2. The method according to claim 1, comprising:
combining at least one position of the playhead and at least one corresponding freezed-frame of the media data presentation together to form at least one combination, and
associating a playhead information to said at least one combination in such a way that said at least one combination is identified by the playhead information.

3. The method according to claim 1, wherein the media message comprising at least one playhead information is transmitted via a short range connection, preferably a short-range wireless connection.

4. The method according to claim 1, wherein the playhead indicates graphically or numerically an instantaneous position of a media data presentation in relation to a timeline of said media data presentation, while running on a wireless terminal.

5. A wireless terminal, said wireless terminal comprising
a transmitter for sending at least one media data message, said media data message comprising media data and a metadata,
a memory unit in which a program application is stored, and
a control unit for controlling execution of the program application,
a display unit for presenting a media data presentation and programmable selecting members for controlling said one media data presentation,
wherein the control unit and program application of the wireless terminal are configured to:
stop presentation of said media data presentation and a playhead at a point controlled by a user of said wireless terminal,
mark a position of said playhead selected by said user of said wireless terminal and a freezed-frame of the media data presentation to be identified by a playhead information,
insert the playhead information to the metadata, and identify the playhead information to the metadata,
send the media message comprising at least one playhead information from the wireless terminal to another wireless terminal for enabling a user of said other wireless terminal to start presentation of said media data presentation and said playhead according to said playhead information at said position marked by said user of the sending terminal.

6. The wireless terminal according to claim 5, wherein the control unit and program application are configured to:
combine at least one position of the playhead and at least one corresponding freezed-frame of the media data presentation together arranged to form at least one combination, and
combine a playhead information to said at least one combination in such a way that said at least one combination is arranged to be identified by the playhead information.

7. The wireless terminal according to claim 5, wherein the control unit and program application are configured to: indicate the playhead graphically or numerically as an instantaneous position of a media data presentation in relation to a timeline of said media data presentation, while running on a display unit.

8. A method comprising receiving at least one playhead information in at least one media message sent over a wireless network by a user of a sending terminal, where at least one playhead is indicating progress of at least one media data presentation for presentation on a receiving wireless terminal, wherein
the at least one media message comprises media data and a metadata with an indication of a point marked by the user of the sending terminal in media data selected by the user of the sending terminal for a user of the receiving wireless terminal,
the method further comprising the receiving wireless terminal identifying at least one playhead information from said metadata,
reassembling said at least one media message to at least one media data presentation according to said playhead information, and
presenting said at least one media data presentation according to said playhead information enabling said user of the receiving terminal to identify the point in the media data marked by said user of said sending terminal.

9. The method according to claim 8, wherein the identifying comprises further reading said at least one playhead information and identifying a combination of at least one position of playhead and at least one corresponding freezed-frame of at least one media data presentation from said at least one playhead information.

10. The method according to claim 9, wherein the reassembling comprises further reconstructing from said combination the media data presentation by synchronizing together said position of playhead and said corresponding freezed-frame of said media data presentation.

11. The method according to claim 8, wherein the identifying further comprises identifying from said combination a source location of said at least one media data presentation.

12. The method according to claim 11, further comprising initiating access to the identified source location and search of a file of the corresponding media data presentation.

13. The method according to claim 8, wherein the presenting comprises presenting a second media data presentation together with at least one first media data presentation according to the first playhead information, said second media data presentation being added to the same media message comprising said first playhead information.

14. The method according to claim 8, wherein the presenting comprises starting at least one media data presentation from at least one position of said playhead.

15. The method according to claim 8, wherein a first position of playhead indicates a starting point of the media data presentation and a second position of playhead indicates a stopping point of the media data presentation.

16. The method according to claim 8, wherein the media data presentation is in at least one of the following formats: text, image, speech, voice, audio, video and animation.

17. A non-transitory memory unit comprising a program stored thereon for use in a wireless terminal for processing by a control unit of said wireless terminal to carry out the method of claim 1.

18. The non-transitory memory unit comprising said program stored thereon in a wireless terminal according to claim 17, said program and the control unit configured to:
combine at least one position of the playhead and at least one corresponding freezed-frame of the media data presentation together arranged to form at least one combination, and
associate a playhead information to said at least one combination in such a way that said at least one combination is arranged to be identified by the playhead information.

19. The non-transitory memory unit comprising said program stored thereon for use in a wireless terminal according to claim 18, said program and the control unit configured to combine a source location of said media data presentation to said combination in such a way that said combination and the source location is arranged to be identified by the playhead information.

20. A non-transitory memory unit for said sending wireless terminal arranged to implement the method according to claim 8.
